(19) United States
(12) Patent Application Publication
(10) Pub. No.: US 2009/0059081 A1
(43) Pub. Date: Mar. 5, 2009

(54) HISTOGRAM DETECTOR FOR CONTRAST RATIO ENHANCEMENT SYSTEM

(75) Inventors: Mark Francis Rumreich, Indianapolis, IN (US); John Alan Hague, Indianapolis, IN (US)

Correspondence Address: FLETCHER YODER P.C., 7915 FM 1960 RD. WEST, SUITE 330, HOUSTON, TX, 77070, US

(73) Assignee: TTE TECHNOLOGY, INC., Indianapolis, IN (US)

(21) Appl. No.: 12/162,273

(22) PCT Filed: Feb. 7, 2006
(86) PCT No.: PCT/US06/04635

§ 371 Date: Jul. 25, 2008

(51) Int. Cl. H04N 5/57

(52) U.S. Cl. 348/672; 348/E05.119

(57) ABSTRACT

The disclosed embodiments relate to a system and method for processing a video signal, comprising assigning pixels from a set of pixels to at least one of a plurality of bins based on a brightness level associated with each pixel of the set of pixels, each of the plurality of bins containing pixels having a brightness level above or below a specified value, and identifying a coarse horizon value corresponding to a first one of the bins that includes a number of pixels corresponding to a brightness level.

### FIELD OF THE INVENTION

The present invention relates generally to display systems. More specifically, the present invention relates to a system and method for enhancing contrast ratio in certain display systems.

### BACKGROUND OF THE INVENTION

This section is intended to introduce the reader to various aspects of art, which may be related to various aspects of the present invention that are described and/or claimed below. This discussion is believed to be helpful in providing the reader with background information to facilitate a better understanding of the various aspects of the present invention. Accordingly, it should be understood that these statements are to be read in this light, and not as admissions of prior art.

Liquid Crystal Displays (LCD) panels are increasingly being used for television display applications mainly due to their light weight and thin profile, as compared to Cathode Ray Tubes (CRTs). However, the performance of LCD panels is still lagging behind CRTs in a number of key areas, one of which is contrast ratio. As an example, the contrast ratio of high-end LCD panels is generally about 500:1, while for a CRT, 10,000:1 is a common ratio.

The contrast ratio may be defined as the ratio of the amount of light of the brightest white to the darkest black of a video frame. Unfortunately, due to their light transmitting properties, pixels of LCD panels transmit enough light, even when in their darkest state, such that a black colored pixel displayed on the LCD panel actually appears to be displayed as a dark gray pixel. Consequently, this significantly lowers the contrast ratio of the LCD panel, which may be more objectionable in low light viewing conditions.

Furthermore, attempting to enhance the contrast ratio of a display device may necessitate obtaining information about the whitest areas of each video frame. Such information is needed, so as to limit the reduction of backlight illumination intensities, thereby avoiding “white reduction”, as appreciated by those skilled in the art. Determining the whitest areas of a video frame can be done with a single peak detector, which finds the brightness value of the brightest pixel in the frame. However, this provides very poor susceptibility to noise and excessive detector wobble for minor scene changes. Further, it limits the amount of contrast enhancement by establishing too strict of a requirement for the backlight illumination.

### SUMMARY OF THE INVENTION

Certain aspects commensurate in scope with the disclosed embodiments are set forth below. It should be understood that these aspects are presented merely to provide the reader with a brief summary of certain forms the invention might take and that these aspects are not intended to limit the scope of the invention. Indeed, the invention may encompass a variety of aspects that may not be set forth below.

The disclosed embodiments relate to a system and method for processing a video signal, comprising assigning pixels from a set of pixels to at least one of a plurality of bins based on a brightness level associated with each pixel of the set of pixels, each of the plurality of bins enumerating pixels having a brightness level above or below a specified value, and identifying a coarse horizon value corresponding to a first one of the bins that includes a number of pixels corresponding to a brightness level. In addition to LCDs, the disclosed system and method may further apply to digital light displays (DLPs), and to liquid crystal on silicon (LCOS) display systems.

### BRIEF DESCRIPTION OF THE DRAWINGS

Advantages of the invention may become apparent upon reading the following detailed description and upon reference to the drawings in which:

FIG. 1 is a block diagram of an LCD panel in accordance with an exemplary embodiment of the present invention;

FIG. 2 is a block diagram of a contrast ratio enhancing system in accordance with an exemplary embodiment of the present invention;

FIG. 3 is a block diagram of a white horizon finder in accordance with an exemplary embodiment of the present invention;

FIG. 4 is a block diagram of a programmable horizon finder in accordance with an exemplary embodiment of the present invention; and

FIG. 5 is flow chart depicting a method for obtaining a whiteness level in a video frame in accordance with an exemplary embodiment of the present invention.

### DETAILED DESCRIPTION

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

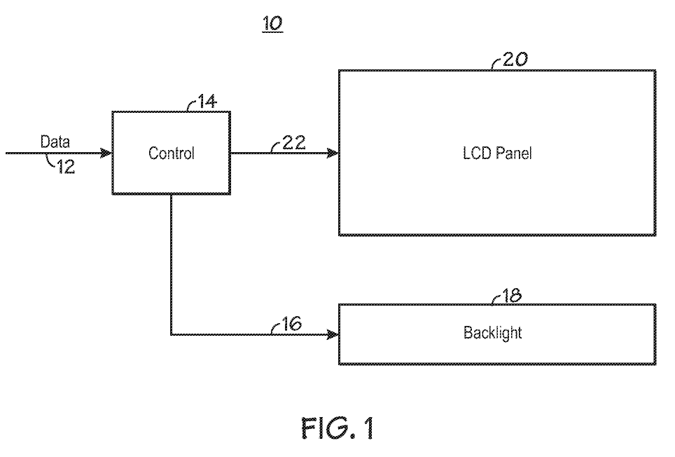

Referring to FIG. 1, a configuration of an exemplary LCD panel system 10 in accordance with an exemplary embodiment of the present invention is shown. The figure depicts an LCD panel 20 and an illumination source 18, such as a backlight, controlled by a control system 14. The control system 14, receives data 12, which may include video backlight illumination and liquid crystal pixel data values. The control system 14 may use the data 12 to simultaneously adjust the backlight and the pixel values to enhance the contrast ratio of the LCD panel 20. Accordingly, data 22 provided by the control system 14 goes into the LCD panel 20 for adjusting the pixel values. Similarly, data 16 produced by the control system 14 is transmitted into the backlight 18 for adjusting the illumination signal, of the video.

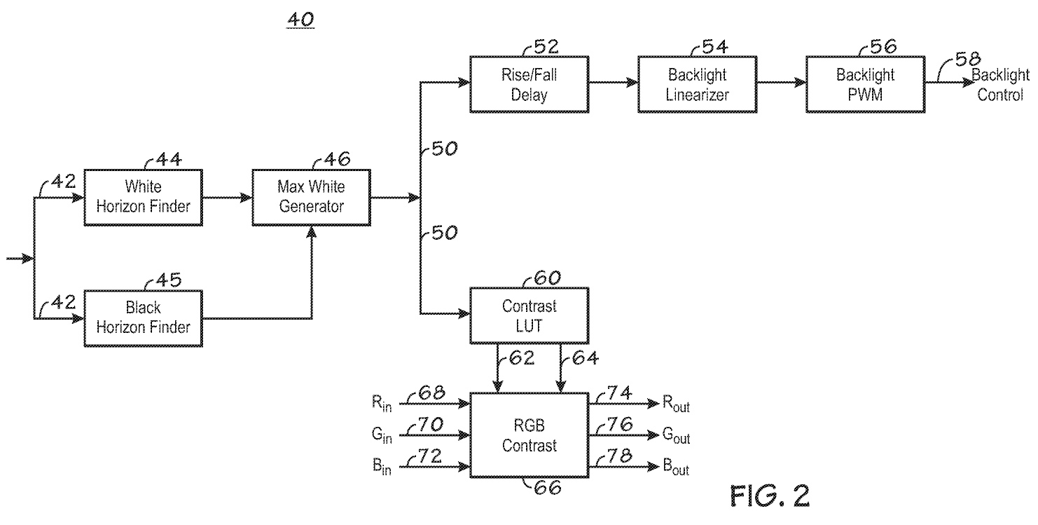

Turning now to FIG. 2, a contrast ratio enhancement control system 40 in accordance with an exemplary embodiment of the present invention is shown. The description set forth of the control system 40 pertains to components controlling the video backlight illumination and the pixel values of the LCD panel 20. Accordingly, a white horizon finder 44 and a black horizon finder 45 receive respective backlight illumination component data 42. The white horizon finder 44 and the black horizon finder 45 respectively determine statistical information relating to the brightness levels, and their distribution throughout a video frame. Information obtained by the white horizon finder 44 and the black horizon finder 45 is provided to a maximum white generator 46. The maximum white generator 46 controls the backlight illumination, while adjusting the liquid crystal pixel values. In accordance with exemplary embodiments of the present invention, the two are adjusted in a complementary fashion to enhance the contrast ratio of the LCD panel 20.

The maximum white generator 46 adjusts the backlight illumination by determining the brightness of the brightest area of the video frame. This information is then utilized to illuminate the LCD panel 20, for example by cold-cathode-fluorescent (CCF) lamps. Accordingly, to improve the contrast ratio, a reduced backlight illumination is desired. However, as one of ordinary skilled in the art would appreciate, reducing the backlight illumination too much may cause an undesired “white reduction” of the video frame. In order to avoid this, brightness information obtained by the maximum white generator 46 is further utilized to modify the pixel values of the LCD panel to compensate for possible insufficient backlight illumination.

The maximum white generator 46 produces output data 50 for modulating the backlight illumination, while adjusting red, green and blue (RGB) input values of the LCD panel 20. The data 50 may be delivered to backlight control circuitry, which outputs backlight control data 58. Such backlight control circuitry may include: a rise/fall delay 52 which compensates for time misalignments between the backlight illumination and the pixel raster scan. This may prevent viewer perceived white flashes appearing on a screen, which are generally undesirable. Also included in the backlight control circuitry are a backlight linearizer 54 which compensates for nonlinearity in the light characteristic of the backlight, and a backlight pulse width modulator (PWM) 56 which controls the illumination level of the backlight.

Further, to compensate for backlight illumination, maximum white data 50 is produced by the maximum white generator 46 for modifying the pixel values of the LCD panel 20 in a non-linear gamma-corrected domain. Accordingly, the data 50 is delivered to a contrast look-up table (CLUT) 60, which stores adjustment values that are formatted as an RGB offset 62 and an RGB gain-value 64. The RGB offset value 62 and the RGB gain-value 64 are delivered to an RGB contrast circuit 66. Accordingly, input RGB pixel values 68-72 are combined with the RGB offset 62 and the RGB gain-value 64 to output gamma-corrected RGB pixel values 74-78.

In enhancing the contrast ratio of the display device 20, the white horizon finder 44 may acquire statistical information quantifying near-white levels in each video frame for modulating the backlight illumination. Such information may advantageously limit the reduction of the backlight illumination in order to avoid white reduction. Further, obtaining statistical information of brightness levels reduces errors in backlight intensity modulation, rendering the contrast ratio enhancement system less susceptible to noise.

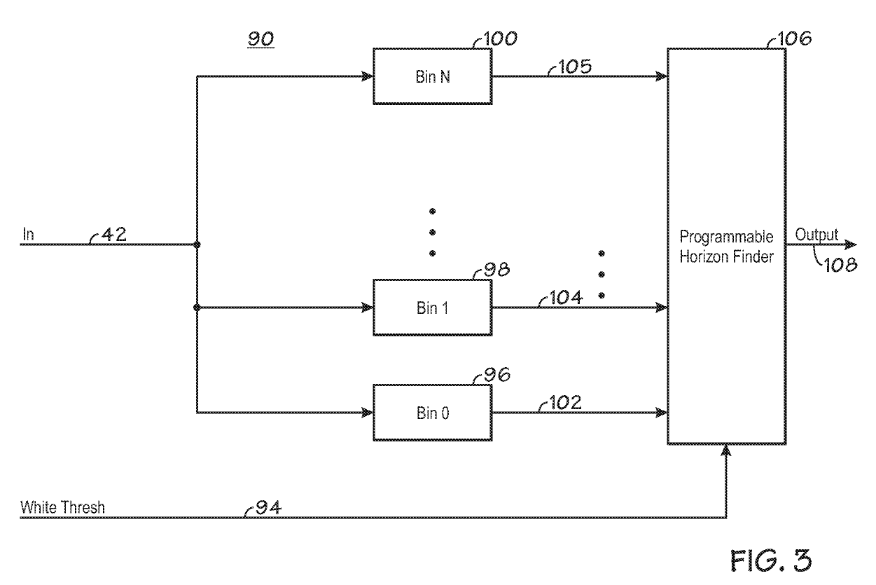

Referring to FIG. 3, an exemplary block diagram in accordance with an exemplary embodiment of the present invention is illustrated. The block diagram depicts a system 90 for obtaining statistical information of whiteness levels or white and near-white levels in a video frame, as implemented by the white horizon finder 44. In an exemplary embodiment, luminance data 42 is delivered to an array of bins 96-100. Although three bins are shown in FIG. 3, other numbers of bins may be employed based on system design criteria. An exemplary embodiment of the present invention employs nine bins. The purpose of each of the bins 96-100 is to respectively count the number of pixels in each video frame that fall above a certain whiteness level. Thus, in an exemplary embodiment, the bin 96 may include, for example, all pixels having values of shades of gray that are above 176. Similarly, bin 100 may include all pixels having values of shades of gray that are above 210. In this manner, a histogram of nine bins is obtained, where each bin total enumerates the number of pixels falling above a certain whiteness level.

The bins 96-100 produce respective pixel count data 102-105, delivered to a programmable horizon finder 106. The purpose of the programmable horizon finder 106 is to compare each of the data inputs 102-105 to a configurable white threshold 94. Such a comparison may yield the bin number 96-100 having the quantity of white and near white pixels exceeding and/or matching the white threshold 94. Hence, knowing the threshold-matching bin number and its corresponding whiteness level may determine the effective whiteness area contained in the video frame. This information may further be used by the maximum white generator 46 to determine the degree of modulation needed for the backlight. Consequently, the programmable horizon finder 106 produces a data output 108 for each video frame quantifying the bin number matching the threshold 94. In an exemplary embodiment, the resolution of the data output is six bits. Accordingly, an advantage of the system 90 is its ability to quantify white and near white levels of a video frame via sixty four states of resolution, while employing a significantly reduced number of hardware-implemented bins to classify the sixty four states of resolution. It is believed that the use of nine bins with six bit resolution provides an effective tradeoff between resolution and system complexity.

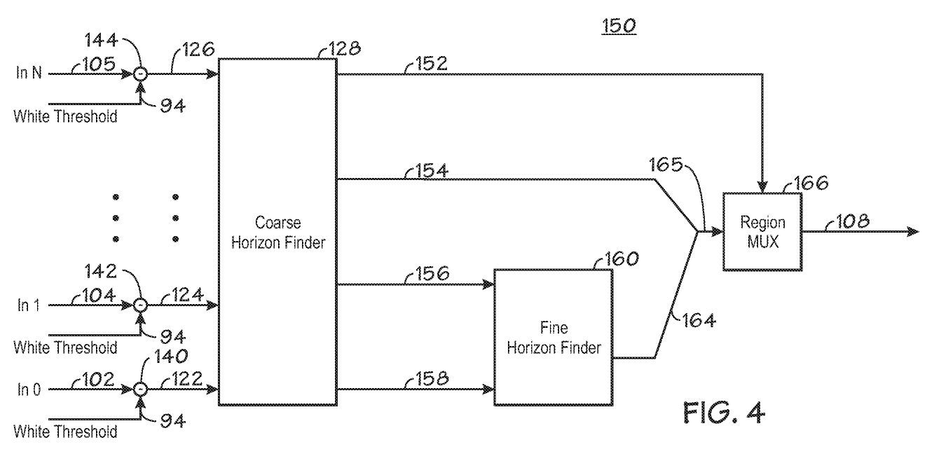

FIG. 4 is a block diagram in accordance with an exemplary embodiment of the present technique. The block diagram depicts a system 150 implemented by the programmable horizon finder 106 (FIG. 3). In the preferred embodiment, the nine sets of data 102-105 (FIG. 3) enter respective subtractors 140-144. Each of the subtractors 140-144 is further provided with the white threshold 94. The white threshold 94 is subtracted from each of the data 102-105, yielding respective data sets 122-126. Subtracting the threshold value 94 from the input data 102-105 conveniently enables finding which one of the nine bins 96-100 has a pixel count approximately matching the white threshold value 94. Accordingly, coarse horizon finder 128 accepts the input data 122-126 and produces four sets of data 152-158. Among these, three-bit data 154 corresponds to a coarse horizon value. This value represents the highest bin number whose total pixel count is below the white threshold 94. For example, assuming the total number of pixels exactly matching the white threshold 94 corresponds to a virtual bin number disposed halfway between bins 3 and 4 or virtual bin number 3.5. Thus, the three-bit data 154 produced by the coarse horizon finder 128 would represent a value of 3. The remaining fractional resolution is obtained via respective data sets 156 and 158 delivered to a fine horizon finder 160. These data sets identify coarse horizon finder input values which straddle above and below zero, in accordance with the subtracted white threshold-data sets 122-126. Accordingly, the data sets 156 and 158 are utilized by the fine horizon finder 160 to obtain an approximation corresponding to the fractional bin number. In the example where virtual bin 3.5 has total pixel count matching the white threshold 94, the fine horizon finder 160 produces three-bit data 164 representing a value of 0.5. The three-bit data 154 and three-bit data 164 are further combined by the system 150 to obtain six-bit data 165 representing the number 3.5. Consequently, the data 165 corresponds to the virtual bin number whose total pixel count matches the threshold 94.

Further, output data 152 is produced by the coarse horizon finder 128 to indicate cases where all of the bins 96-100 are either above or below the threshold value 94. In that case, the signal 152 forces region mux 166 to output an appropriate value, namely, zero or a maximum value for the illumination signal of a video frame. Hence, the region mux 166 produces these latter values as signal 108. In cases where not all of the bins are above or below the threshold 94, the resultant signal 165 is also delivered to the region mux 166 for producing the appropriate data represented by the signal 108. Accordingly, the signal 108 is delivered to the maximum white generator 46 for modulating the backlight illumination.

System 150 may be similarly implemented in the black horizon finder 45. Such an implementation of the system 150 may enable obtaining blackness levels in a video frame. Accordingly, a black horizon finder assigns pixels into bins based on pixels having a brightness value below a specified level. Thus, the black horizon finder may be used to further enhance the contrast ratio of the display device 20.

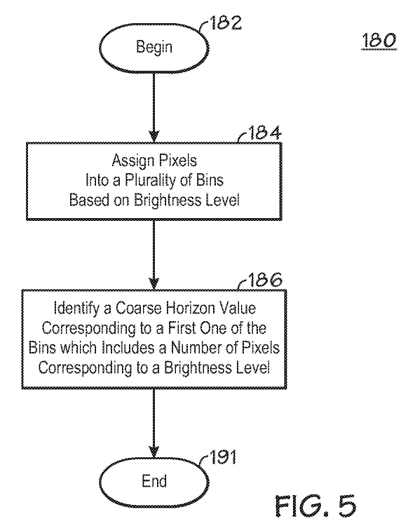

FIG. 5 depicts a flow chart outlining a method in accordance with exemplary embodiments of the present invention. The flow chart generally referred to by reference numeral 180 depicts processing steps in obtaining whiteness levels of a video frame. Accordingly, the method begins at block 182 where the pixel brightness data 42 enters the white horizon finder 44. At block 184, pixels are assigned into a plurality of bins based on a brightness level associated with each pixel. Thus, each of the plurality of bins enumerates pixels having a brightness level above or below a specified value. At block 186 a coarse horizon value is identified, corresponding to a first one of the bins which includes the number of pixels corresponding to a brightness level. Lastly, the method ends at block 191.

While the invention may be susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the spirit and scope of the invention as defined by the following appended claims.

What is claimed is:

1. A method for processing a video signal, the method comprising:
assigning pixels from a set of pixels to at least one of a plurality of bins based on a brightness level associated with each pixel of the set of pixels, each of the plurality of bins enumerating pixels having a brightness level above or below a specified value; and
identifying a coarse horizon value corresponding to a first one of the plurality of bins that includes a number of pixels corresponding to a brightness level.

2. The method recited in claim 1, comprising interpolating a value corresponding to a number of pixels in a second one of the plurality of bins adjacent to the first one of the plurality of bins.

3. The method recited in claim 2, comprising refining the coarse horizon value based on the interpolation to obtain a fine horizon value.

4. The method recited in claim 3, comprising controlling a video signal in accordance with the coarse horizon value and the fine horizon value.

5. The method recited in claim 1, wherein the plurality of bins comprises nine bins and the set of pixels is assigned to at least a one of the plurality of bins to form a histogram, wherein each of the nine bins contains a number of pixels having a brightness level above or below a specific value.

6. The method recited in claim 3, wherein the coarse horizon value and the fine horizon value each comprise three bits of data for a video frame.

7. The method recited in claim 1, comprising subtracting a threshold value from the number of pixels contained in each one of the plurality of bins to obtain a zero crossing corresponding to the one of the plurality of bins with a value representing a number of pixels matching the threshold.

8. The method recited in claim 3, comprising combining the coarse horizon value and the fine horizon value to produce a brightness horizon value comprising six bits of data for each video frame.

9. The method recited in claim 1, comprising modulating the brightness level in each video frame based on the first one of the plurality of bins.

10. A video unit configured to generate a video frame, the video unit comprising:
a first module configured to determine a brightness value for a plurality of pixels on the video frame;
a second module configured to assign the pixels to at least one of a plurality of bins according to the brightness values of the pixels; and
a third module configured to determine a horizon based on the number of pixels in one or more of the plurality of bins.

11. The video unit recited in claim 10, wherein the first module is configured to determine a whiteness or blackness value for a plurality of pixels in a video frame.

12. The video unit recited in claim 10, wherein the plurality of bins comprises nine bins and a set of pixels is assigned to at least one of the plurality of bins to form a histogram, wherein each of the nine bins contains a number of pixels having a brightness level above or below a specific value.

13. The video unit recited in claim 10, wherein the third module comprises a coarse horizon finder adapted to obtain a coarse horizon value corresponding to a first one of the plurality of bins that includes a number of pixels matching a brightness level threshold.

14. The video unit recited in claim 13, wherein the third module comprises a fine horizon finder adapted to refine the coarse horizon value.

15. The video unit recited in claim 13, wherein the third module utilizes the brightness level threshold to obtain the horizon for each video frame.

16. The video unit recited in claim 10, comprises a module for modulating an illumination signal in each video frame based on the white or black horizon.

17. A system for processing a video signal of a video frame, the system comprising:
means for assigning pixels from a set of pixels to at least one of a plurality of bins based on a brightness level associated with each pixel of the set of pixels, each of the plurality of bins enumerating pixels having a brightness level above or below a specified value; and
means for identifying a coarse horizon value corresponding to a first one of the bins that includes a number of pixels corresponding to a brightness level.

18. The system recited in claim 17, comprising means for interpolating a value corresponding to a number of pixels in a second one of the bins adjacent to the first one of the bins.

19. The system recited in claim 17, comprising means for refining the coarse horizon value based on the interpolation to obtain a fine horizon value.

20. The system recited in claim 19, comprising means for controlling the video signal in accordance with the coarse horizon value and the fine horizon value.
